(19) United States
(12) Patent Application Publication
(10) Pub. No.: US 2025/0166871 A1
(43) Pub. Date: May 22, 2025

(54) EXTREMELY LOW THERMAL CONDUCTIVITY DIRECT CURRENT LINE FORMING METHOD AND DIRECT CURRENTLINE FOR QUANTUM COMPUTER

(71) Applicant: YANGTZE DELTA INDUSTRIAL INNOVATION CENTER OF QUANTUM SCIENCE AND TECHNOLOGY, Suzhou (CN)

(72) Inventors: Tian LUAN, Suzhou (CN); Ming ZHANG, Suzhou (CN); Jiawei LI, Suzhou (CN); Haifeng LI, Suzhou (CN); Yun WANG, Suzhou (CN)

(21) Appl. No.: 19/033,542

(22) Filed: Jan. 22, 2025

Related U.S. Application Data
(63) Continuation of application No. PCT/CN2024/105305, filed on Jul. 12, 2024.

(30) Foreign Application Priority Data
Sep. 8, 2023 (CN) 202311157184.8

(51) Int. Cl. H01B 13/02; H01B 13/22

(52) U.S. Cl. CPC H01B 13/0207; H01B 13/22

(57) ABSTRACT

The application discloses an extremely low thermal conductivity direct current line forming method, including: adopting a guide wire made of a titanium alloy material, wrapping the guide wire with an insulating paint layer to form a wire, twisting the wire for multiple times to sequentially form a small wire pair, a large wire pair, a wire set and a wire core, and wrapping the wire core with an outer sheath made of a non-metallic material to form a direct current line. The application further discloses a direct current line used for a quantum computer and manufactured through the extremely low heat conductivity direct current line forming method.

### CROSS-REFERENCE TO RELATED APPLICATIONS

The present application is a continuation of International Application No. PCT/CN2024/105305, with an international filing date of Jul. 12, 2024, which is based upon and claims priority to Chinese Patent Application No. 202311157184.8, filed on Sep. 8, 2023, the entire contents of all of which are incorporated herein by reference.

### TECHNICAL FIELD

The present disclosure relates to a technical field of cables, and more accurately to an extremely low thermal conductivity direct current line forming method and direct current line for quantum computer.

### BACKGROUND

The direct current cable can be used as a transmission cable for direct current signals, and serves as a communication function between the inside and outside the device. The direct current line is required to have an extremely low thermal conductivity when the operating ambient temperature inside the device is low. The existing direct current line is mainly applied to a normal temperature environment and has fewer paths. In order to ensure signal transmission and avoid streaming, the mainstream process mode at present is left-right twisting (SZ-shaped stranding), which is relatively mature. Each wire group is arranged in accordance with the principle that the lay length of adjacent wire groups in each layer is different, and there are 1+6, 1+6+12, and other arrangements. Additionally, a metal shielding layer and an insulating layer are wrapped outside after being twisted, so that the strength and the anti-interference capability of the cable are ensured, the volume of the cable is increased, and the bending property is reduced. Further, the existing direct current line generally has a metal center reinforcement and a shielding layer, with high thermal conductivity.

Taking the direct current line used in the quantum computer as an example, the quantum chip need to operate in a vacuum and extremely low temperature environment to achieve the desired performance. In order to ensure a low temperature state, it is necessary to prevent the cable penetrating into the inside from transmitting too much heat. In addition, the quantum compute has compact internal space and requires the cable to be small and easy to bend. The direct current line produced by the existing process is difficult to meet the requirements of low thermal conductivity, small volume and easy bending, and thus is difficult to be applied to a device with low operating environment temperature and compact space.

In summary, there is a need in the art for a novel direct current line forming method to produce a direct current line with extremely low thermal conductivity, smaller volume, and more flexibility.

### SUMMARY

The present disclosure aims at providing an extremely low thermal conductivity direct current line forming method, using a low thermal conductivity wire without a central reinforcement member twisted multiple times to form a wire core in an arrangement of 2*2*2*3, reducing the thermal conductivity of the direct current line and the bending radius of the cable.

The present disclosure further aims at providing a direct current line used for a quantum computer, manufactured through the extremely low heat conductivity direct current line forming method.

In order to achieve the above purpose, the present disclosure provides an extremely low thermal conductivity direct current line forming method, comprising:
(A) selecting a guide wire made of a titanium alloy material, wrapping the outside of the guide wire with an insulating paint layer to form a wire, and winding the wire on a wire shaft;
(B) selecting two wire shafts wound with wires, pulling out the wires from the wire shafts, respectively, and securing wire ends of the two wires on a first wire collecting shaft;
(C) the two wire shafts rotating around a midpoint of a line connecting the two wire shafts, making the two wires twisted;
(D) a first wire collecting shaft rotating to collect and wind the two twisted wires on the first wire collecting shaft, forming a small wire pair after the two wires are twisted and collected;
(E) pulling out the two small wire pairs from the first wire collecting shaft, securing the wire ends of the small wire pairs on a second wire collecting shaft, the two first wire collecting shafts rotating around a midpoint of a line connecting the two first wire collecting shafts, collecting and winding the two twisted small wire pairs on the second wire collecting shaft, and forming a large wire pair after the two small wire pairs are twisted and collected;
(F) pulling out the two large wire pairs from the second wire collecting shaft, securing the wire ends of the large wire pairs on a third wire collecting shaft, the two second wire collecting shafts rotating around a midpoint of a line connecting the two second wire collecting shafts, collecting and winding the two twisted large wire pairs on the third wire collecting shaft, and forming a wire set after the two large wire pairs are twisted and collected;
(G) pulling out the three wire sets from the third wire collecting shaft, securing the wire ends of the wire sets, the three third wire collecting shafts being arranged in a triangle and rotating around a center point of the triangle, collecting and twisting the three wire sets, and forming a wire core after the wire sets are twisted and collected;
(H) weaving an outer sheath made of a non-metallic material outside the wire core to form a direct current line.

Preferably, in the step (D), the first wire collecting shaft rotates in the same direction as the wire shaft.

Preferably, in the step (E), the second wire collecting shaft rotates in the same direction as the first wire collecting shaft.

Preferably, in the step (F), the third wire collecting shaft rotates in the same direction as the second wire collecting shaft.

Preferably, in the step (C), the two wire shafts rotate clockwise at a constant speed around a midpoint of a line connecting the two wire shafts.

Preferably, in the step (D), a pitch of the formed small wire pairs ranges from 6 to 10 mm.

Preferably, in the step (E), a pitch of the formed large wire pairs ranges from 8 to 14 mm.

Preferably, in the step (F), a pitch of the formed wire set ranges from 16 to 20 mm.

Preferably, in the step (A), the thickness of the insulating paint layer is 0.01-0.03 mm.

The present disclosure provides a direct current line used for a quantum computer, manufactured through the extremely low heat conductivity direct current line forming method.

Compared with the prior art, the extremely low thermal conductivity direct current line forming method and the direct current line used for a quantum computer have the advantages that: the twisting directions in the steps of the extremely low thermal conductivity direct current line forming method are the same, which can effectively avoid the mutual influence of the steps and constrain the twisting force, and the operation is convenient and rapid; the direct current line adopts a wire with extremely low thermal conductivity and a non-metal outer sheath instead of adopting a metal reinforcement member and a shielding layer, thereby effectively reducing the thermal conductivity; each path of the direct current lines is twisted compactly and not easy to loosen, and is repeatedly twisted in multiple steps, thereby reducing signal interference between direct current signal loops without the use of a metal shielding layer; and the direct current line has no internal reinforcement member, and is smaller in volume, more flexible and easier to bend as a whole, with smaller bending radius, so that it can be arranged in a tight space more conveniently.

### BRIEF DESCRIPTION OF THE DRAWINGS

In order to more clearly explain the technical solutions in the present disclosure or the prior art, drawings required in the embodiments or the prior art will be briefly described below. Obviously, the drawings in the following description are some embodiments of the present disclosure. For those skilled in the art, other drawings may be obtained from these drawings without any creative effort.

FIG. 1 is a flow diagram of an extremely low thermal conductivity direct current line forming method according to the present disclosure.

FIG. 2 is a schematic diagram of a wire shaft rotation process in step (C) of an extremely low thermal conductivity direct current line forming method according to the present disclosure.

FIG. 3 is a schematic diagram of a third wire collecting shaft rotation process in step (G) of an extremely low thermal conductivity direct current line forming method according to the present disclosure.

FIG. 4 is a schematic cross-sectional view of a wire for a direct current line used for a quantum computer according to the present disclosure.

FIG. 5 is a schematic cross-sectional view of a direct current line used for a quantum computer according to the present disclosure.

### DETAILED DESCRIPTION OF THE EMBODIMENTS

The technical solutions of the examples of the present disclosure will be described clearly and completely as follows with reference to the drawings in the examples of the present disclosure. Obviously, the described embodiments are part of, but not all of, the embodiments of the present disclosure. Based on the embodiments of the present disclosure, all the other embodiments obtained by those skilled in the art without paying any creative work fall within the protection scope of the present disclosure.

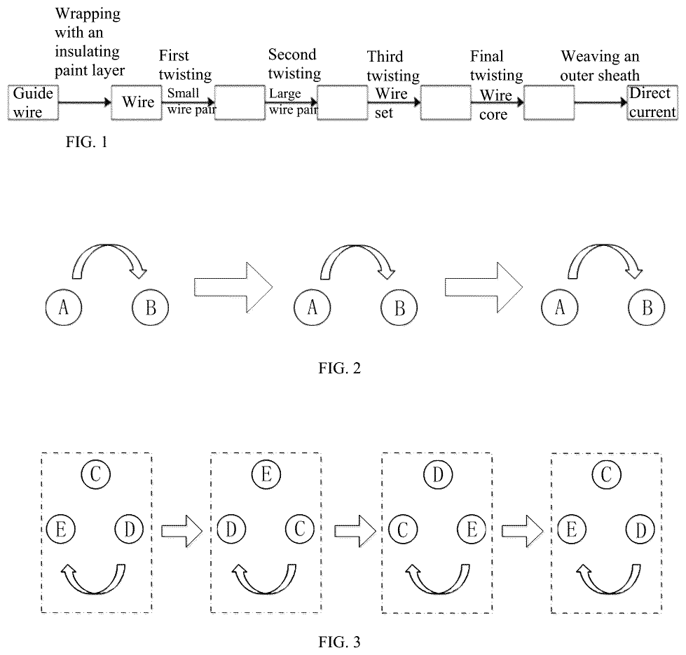

As shown in FIG. 1, an extremely low thermal conductivity direct current line forming method provided by the present disclosure comprises:
(A) selecting a guide wire made of a titanium alloy material, wrapping the outside of the guide wire with an insulating paint layer to form a wire, and winding the wire on a wire shaft;
(B) selecting two wire shafts wound with wires, pulling out the wires from the wire shafts, respectively, aligning with each other and securing wire ends of the two wires on a first wire collecting shaft;
(C) the two wire shafts rotating around a midpoint of a line connecting the two wire shafts at a constant speed, such that the wire is gradually released from the wire spool, making the two wires twisted;
(D) a first wire collecting shaft rotating in the same direction as the wire shaft at a constant speed to collect and wind the two twisted wires on the first wire collecting shaft, wherein the wire is in a straightening state during the process of collection and winding, forming a small wire pair after the two wires are twisted and collected;
(E) pulling out the two small wire pairs from the first wire collecting shaft, securing the wire ends of the small wire pairs on a second wire collecting shaft, the two first wire collecting shafts rotating at a constant speed around a midpoint of a line connecting the two first wire collecting shafts, wherein the second wire collecting shaft rotates in the same direction as the first wire collecting shaft at a constant speed, collecting and winding the two twisted small wire pairs on the second wire collecting shaft, wherein the small wire pairs are in a straightening state during the process of collection and winding, and forming a large wire pair after the two small wire pairs are twisted and collected;
(F) pulling out the two large wire pairs from the second wire collecting shaft, securing the wire ends of the large wire pairs on a third wire collecting shaft, the two second wire collecting shafts rotating at a constant speed around a midpoint of a line connecting the two second wire collecting shafts, wherein the third wire collecting shaft rotates in the same direction as the second wire collecting shaft at a constant speed, collecting and winding the two twisted large wire pairs on the third wire collecting shaft, wherein the large wire pairs are in a straightening state during the process of collection and winding, and forming a wire set after the two large wire pairs are twisted and collected, the wire set having a structure of 2*2*2;
(G) pulling out the three wire sets from the third wire collecting shaft, securing the wire ends of the wire sets, the three third wire collecting shafts being arranged in an isosceles triangle and rotating around a center point of the isosceles triangle, rotating in the same direction as the third wire collecting shaft at a constant speed, collecting and twisting the three wire sets, wherein the wire sets are in a straightening state during the process, and forming a wire core after the wire sets are twisted and collected, the wire core having a structure of 2*2*2*3;
(H) weaving an outer sheath made of a non-metallic material outside the wire core to form a direct current line.

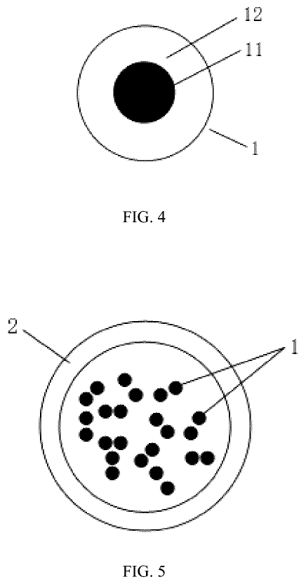

Referring to FIG. 4, the thickness of an insulating paint layer 12 in step (A) is 0.01-0.03 mm, the thermal conductivity of a guide wire 11 made of a titanium alloy material is very low, and the diameter of a wire 1 formed after wrapping the insulating paint layer 12 is very small, ensuring a low thermal conductivity and small volume of the direct current line.

Referring to FIG. 2, in step (C), when the two wire shafts A and B rotate for one turn to return to the initial position, the two wires are twisted to form a small wire pair. The distance of the twist-shaped structure on the small wire pair is a pitch, and the pitch of the small wire pair ranges from 6 to 10 mm; preferably, the pitch of each small wire pair is different.

In step (E), a pitch of the large wire pairs ranges from 8 to 14 mm; preferably, the pitch of each large wire pair is different.

In step (F), a pitch of the wire set ranges from 16 to 20 mm; preferably, the pitch of each wire set is different.

Preferably, in step (C), the two wire shafts rotate clockwise at a constant speed around a midpoint of a line connecting the two wire shafts. The subsequent first wire collecting shaft, the second wire collecting shaft and the third wire collecting shaft rotate clockwise at a constant speed, which can avoid the steps interacting with each other and constrain the twisting force.

Referring to FIG. 3, in step (G), the three third wire collecting shafts C, D and E are arranged in an isosceles triangle, and rotate clockwise at a constant speed. The wire core has no requirement of pitch and is combined depending on the friction between the wire sets, making it less likely to come loose.

Referring to FIG. 5, the direct current line for a quantum computer manufactured in step (H) has a wire core 1 with a structure of 2*2*2*3. The wire core 1 is externally wrapped with a non-metallic outer sheath 2. The direct current line used for the quantum computer is provided with 24 paths of communication channels, and the non-metallic outer sheath 2 wraps around the 24-paths wire core 1 so as to isolate the heat transfer and further reduce the thermal conductivity.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Accordingly, the present disclosure will not be limited to those embodiments shown herein, but will conform to the broadest scope consistent with the principles and novel features disclosed herein.

What is claimed is:

1. An extremely low thermal conductivity direct current line forming method, comprising:
(A) selecting a guide wire made of a titanium alloy material, wrapping the outside of the guide wire with an insulating paint layer to form a wire, and winding the wire on a wire shaft;
(B) selecting two wire shafts wound with wires, pulling out the wires from the wire shafts, respectively, and securing wire ends of the two wires on a first wire collecting shaft;
(C) the two wire shafts rotating around a midpoint of a line connecting the two wire shafts, making the two wires twisted;
(D) a first wire collecting shaft rotating to collect and wind the two twisted wires on the first wire collecting shaft, forming a small wire pair after the two wires are twisted and collected;
(E) pulling out the two small wire pairs from the first wire collecting shaft, securing the wire ends of the small wire pairs on a second wire collecting shaft, the two first wire collecting shafts rotating around a midpoint of a line connecting the two first wire collecting shafts, collecting and winding the two twisted small wire pairs on the second wire collecting shaft, and forming a large wire pair after the two small wire pairs are twisted and collected;
(F) pulling out the two large wire pairs from the second wire collecting shaft, securing the wire ends of the large wire pairs on a third wire collecting shaft, the two second wire collecting shafts rotating around a midpoint of a line connecting the two second wire collecting shafts, collecting and winding the two twisted large wire pairs on the third wire collecting shaft, and forming a wire set after the two large wire pairs are twisted and collected;
(G) pulling out the three wire sets from the third wire collecting shaft, securing the wire ends of the wire sets, the three third wire collecting shafts being arranged in a triangle and rotating around a center point of the triangle, collecting and twisting the three wire sets, and forming a wire core after the wire sets are twisted and collected;
(H) weaving an outer sheath made of a non-metallic material outside the wire core to form a direct current line.

2. The extremely low thermal conductivity direct current line forming method of claim 1, wherein in the step (D), the first wire collecting shaft rotates in the same direction as the wire shaft.

3. The extremely low thermal conductivity direct current line forming method of claim 2, wherein in the step (E), the second wire collecting shaft rotates in the same direction as the first wire collecting shaft.

4. The extremely low thermal conductivity direct current line forming method of claim 3, wherein in the step (F), the third wire collecting shaft rotates in the same direction as the second wire collecting shaft.

5. The extremely low thermal conductivity direct current line forming method of claim 4, wherein in the step (C), the two wire shafts rotate clockwise at a constant speed around a midpoint of a line connecting the two wire shafts.

6. The extremely low thermal conductivity direct current line forming method of claim 1, wherein in the step (D), a pitch of the formed small wire pairs ranges from 6 to 10 mm.

7. The extremely low thermal conductivity direct current line forming method of claim 1, wherein in the step (E), a pitch of the formed large wire pairs ranges from 8 to 14 mm.

8. The extremely low thermal conductivity direct current line forming method of claim 1, wherein in the step (F), a pitch of the formed wire set ranges from 16 to 20 mm.

9. The extremely low thermal conductivity direct current line forming method of claim 1, wherein in the step (A), the thickness of the insulating paint layer is 0.01-0.03 mm.

10. A direct current line used for a quantum computer, which is manufactured through the extremely low heat conductivity direct current line forming method of claim 1.
